(19) United States
(12) Patent Application Publication
(10) Pub. No.: US 2022/0188914 A1
(43) Pub. Date: Jun. 16, 2022

(54) A SYSTEM AND METHOD FOR AUTOMATED BID CONFIGURATION AND SEARCH ENGINE

(71) Applicant: Rupak Kumar Choudhury, Bangalore (IN)

(72) Inventors: Rupak Kumar Choudhury, Bangalore (IN); Nimai Chandra Gorai, Bangalore (IN)

(21) Appl. No.: 16/605,022

(22) PCT Filed: Sep. 19, 2019
(86) PCT No.: PCT/IB2019/057915

§ 371 Date: Oct. 14, 2019

Related U.S. Application Data
(63) Continuation-in-part of application No. 14/318,587, filed on Jun. 28, 2014, now abandoned.

(30) Foreign Application Priority Data
Aug. 13, 2019 (IN) 201941032786

(51) Int. Cl. G06Q 30/08; G06Q 30/06

(52) U.S. Cl. CPC G06Q 30/08; G06Q 30/0625

(57) ABSTRACT

The method (200) for automated bid configuration and search engine comprises the steps submitting (201) bid details in the bid calendar; processing (202) initiated by a Bid Search engine; identifying (203) the eligible bids; and notifying (205) the partners or sellers regarding the new auction. The method further includes receiving (206) the bidding details from the sellers; receiving (207) the search listing by the customer, submitting (208) the selected bids to the bidding engine by the customer, notifying (209) the sellers for the reverse auction by the bidding engine, bidding (210) by the partner or seller during the Bidding Term, determining a ‘Cool’ bid based on the internal algorithms, accepting (211) of the ‘Cool’ bid by the customer; generation (212) of a voucher for the winning bid and emailing a voucher to the customer; notifying (213) the seller or partner of the winning bid and closing (214) of the auction.

### FIELD OF INVENTION

The embodiment herein generally relates to the field of e-commerce and trading. More specifically, the invention provides a system and method for searching goods and/or services with a desired budget through reverse auctioning process.

### BACKGROUND AND PRIOR ART

With the rapid growth of the Internet has emerged multiple ways of facilitating transactions between buyers and sellers conveniently, quickly, and usually securely. Electronic commerce, commonly referred to as eCommerce, is continuing to grow at an extraordinary rate.

In a typical electronic auctioning system, sellers set up the auctions and buyers bid for the auctions setup by the Sellers. Whereas, in the reverse auctioning systems, buyers set up the auctions and sellers bids for the auctions setup by buyers.

However, in the methods mentioned above, buyers and/or customers will not have options to purchase required goods or service by searching with his/her/their predefined budget/price and choice of sellers through auctioning or bidding process for the intended items.

Therefore, there is a need to develop a new system and method that enables the customers and/or buyers to search for live bids goods and services according to their predefined budget, and purchase them through a completely automated computer enabled auctioning and bidding process from the sellers with the help of the reverse auctioning process.

### OBJECTS OF THE INVENTION

Some of the objects of the present disclosure are described herein below:

A main object of the present invention is to provide a system for automated bid configuration and search engine.

Another object of the present invention is to provide a method for automated bid configuration and search engine.

Still another object of the present invention is to provide a system and method which enables the customers and buyers to search for live bids of goods and services.

Yet another object of the present invention is to provide a system and method which enables the customers and buyers to search for live bids of goods and services with their predefined budget.

Another object of the present invention is to provide a system and method which enables the customers and buyers to search for live bids of goods and services with their predefined budget using reverse auction process.

Another object of the present invention is to provide a system and method that enables the users to initiate an auction for a required goods and services within their budget and preferred vendors.

Yet another object of the present invention is to provide a system and method which provides the buyers an option to define the price and choose the sellers for the same goods or services which further benefits in getting the profit on price and right sellers.

Still another object of the present invention is to provide a system and method that benefits the sellers by informing them on the competitor's price, rankings, services, terms and conditions on selling the goods and/or services to the customer.

Another object of the present invention is to provide a system and method that saves the time of both the buyers and the sellers by eliminating the manual work on this process.

Another object of the present invention is to provide a system and method that helps the users and the sellers on the returns of their spend and time.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

In view of the foregoing, an embodiment herein provides a system and method for automated bid configuration and search engine.

A method for automated bid configuration and search engine for enabling the user to search for the bids for goods or service within the user's or customer's desired budget and preferred vendors 200, according to an embodiment.

According to an embodiment, the method comprises the steps submitting bid details in the bid calendar by the customer 201, processing initiated by a bid search engine 202, identifying eligible bids by the bid search engine 203, notifying the sellers or the partners regarding the new auction 205 and receiving the bidding details from the sellers or partners within the Bid Discovery period 206.

According to an embodiment, the method further includes receiving of the search listing by the customer 207, customer selects multiple bids and initiates a reverse bidding process, submitting the selected bids to the bidding engine by the customer 208; notifying the partners or sellers regarding the reverse auction by the bidding engine and bidding by the partner or seller during the bidding term 209.

According to an embodiment, the further steps in the method are, determining a cool bid based on the internal algorithms, accepting of the cool bid by the customer 211, generation of a voucher for the winning bid 212, emailing a voucher to the customer and notifying the seller or partner of the winning bid 213 and closing of the auction 214.

According to an embodiment, a system 300 for automated bid configuration and search engine is explained in the present invention, wherein the system comprises a user interface, a bidding engine 308, a cloud communication layer and a database 305.

According to an embodiment, the user interface provided for facilitating the customers 302 and partners 301 to register in the system, search and bid in the system and purchase and/or sell the desired goods and services.

According to an embodiment, in the system the bidding engine 308 is configured for managing auctions and bids, and includes a Bid Search component 304, a partner management 309 component, a ranking 310 component, a rating 311 component, a bid status 312 component, an auction 313 component and a bid 314 component.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a flowchart of the Bid Search Process 100 in the Bid Search Engine, according to an embodiment herein;

FIG. 2 illustrates a flow chart showing Auction and Bidding process 200, according to an embodiment herein;

FIG. 3 illustrates a block diagram of the components of the Bid Search engine 300, according to an embodiment herein; and

FIG. 4 illustrates a diagram stating various Bid states 400, according to an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

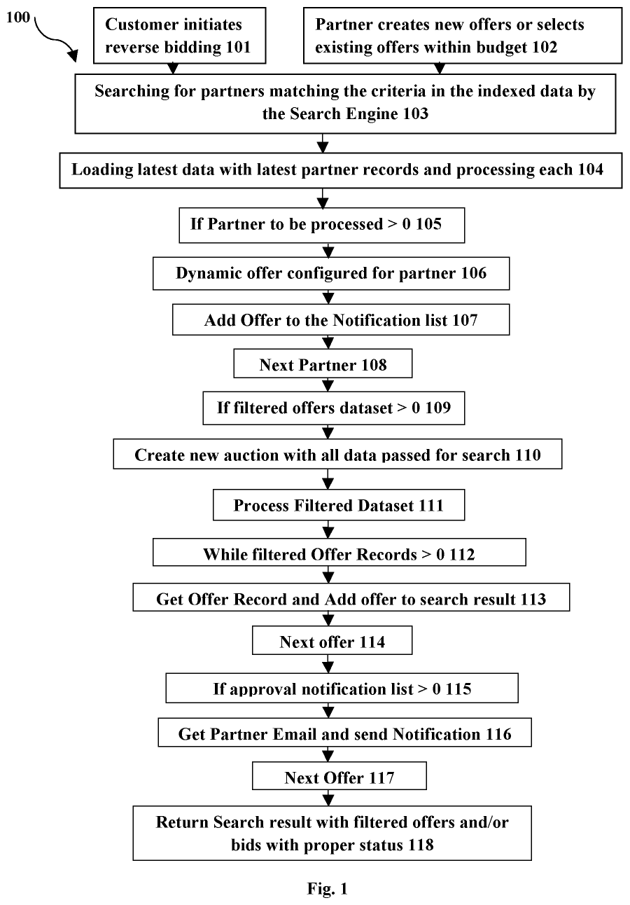

As mentioned above, there is a need to develop a solution for searching real time live bids to purchase the required goods or services with a desired price set by the customer/buyer. The embodiments herein achieve this by providing a cloud based, real time, multi tenant bid search software system, which enables the buyers to search and buy goods or services as per their choice at their own desired budget or lesser price through an automated real time reverse auction process. Referring now to the drawings, and more particularly to FIGS. 1 through 4, where similar reference characters denote corresponding features consistently throughout the figures, there are shown preferred embodiments.

According to an embodiment, Customers are the consumers of services or goods, who search for services or goods within their desired budget in the system. Their search request is considered as an Auction by the system. Partners place one or more bids against this auction.

According to an embodiment, when the user/customer visits the portal/system, he clicks on ‘Sign up’ link which further takes him to the signup form where he enters his emailed as username. The system validates the emailed and displays the Signin link so that the user can provide the password which is again validated by the system. The user is asked to provide a valid mobile number and clicks Signup to submit the form. The Customer Registration Service (CRS) accepts the user registration, enters the details into database, set the customer status as ‘inactive’ and sends the ‘Customer Activation Link’ to the customer's registered email id. The CRS may also generate an OTP (One Time Password) to be sent to the customer's email and SMS, which is used for entering in the OTP verification form after which the customer's records in the system are activated.

According to an embodiment, the system also allows the self registration of the partners, who are the sellers or vendors of the goods or services and are also bidders in the system. After the partner is convinced after meeting the Sales Representative, he is taken to the self registration wizard on the system wherein he provides the basic information, business type, business related information and configure the bidding options wherein he can enable or disable the auto bid option to and build bidding rules using the Bidding RulesBuilder console. Bidding options configuration is optional and can be configured later. The partner is taken to Service Level Agreement (SLA) page after this and once the partner accepts the SLA, the partner registration form is submitted to the Partner Registration Service (PRS) which enters the partner information into the database and initiates the partner onboarding process. The PRS sends the partner registration details to the Sales representative for approval and once approved PRS generates a unique code for the partner along with the ‘Partner activation Link’ and mails the same to the partner's registered email along with the OTP to the partner's mobile number. Once the partner clicks the activation link and enters the OTP, PRS validates the OTP and generates the partner record in the system and generates login credentials for the partner. The partner is provisioned to billing engine, bidding engine and the partner record is pushed to the search engine for indexing. An email containing partner credentials is sent to the partner to complete the partner registration process.

When the customer visits the portal, he enters his desired details in the “bid calendar” and clicks on the search bid. The Search engine component performs full text search in the partner indexed data, according to an embodiment.

According to an embodiment, the result is passed on to Data Loader, which loads the latest data from relational database. The latest partner dataset is passed to the Bidding Options Filter, which further evaluates various rules defined in the “Bidding Options” for each partner and accordingly determines the eligibility of the partner for bidding. The Bidding Options Filter also validates if the budget of the customer for the desired goods or services matches with one or more of the configured offers.

According to an embodiment, all the eligible offer records are added to a list and if there is at least one eligible offer in the list a New auction is created in the system. The list of eligible offers is then passed to the “OfferBid Engine” which loops through each eligible offer.

According to an embodiment, each offer is carefully evaluated by the system for pricing and the appropriate price for the offer is determined by the system. If the offer has “auto-bid” enabled, the system places a new bid against the new auction on behalf of the partner. The offer with Accepted bid status along with the price is added to a search bid list.

According to an embodiment, if the offer has “Review before bidding” enabled, the system initiates an approval flow. The offer with ‘Pending Review’ bid status is added to a search bid list. The partner is notified for approval via SMS and email about the new auction and the partners interested in bidding are expected to provide one or more offers for bidding within the Bidding discovery period. The final bid list is simultaneously passed on to various engines.

According to an embodiment, the Ranking Engine takes care of ranking each bid/offer as per the bid search criteria; Rating engine takes care of attaching the ratings of each bid based on user feedback or other factors; and the Bid status engine changes the states of the bid, the final bid results are sorted by ranking and then by rating. The final result is serialized to JSON and written back to the response which is built in the listing page.

According to an embodiment, the bids result display is paginated. The bids with ‘Accepted’ bid status are listed with ‘Price’ & two buttons which are ‘Buy Now’ & ‘Choose Bidder“. The bids with ‘Pending Review’ bid status are listed with “Pending Review” displayed in the ‘Price’ section. ‘Buy Now’ & ‘Choose Bidder’ buttons are in disabled state. A ‘reverse ajax’ listener is initialized for listing to server's notification on ‘Pending Review’ bids. Customer is shown a message stating that all ‘Pending Review’ bids are being processed and may take some time.

According to an embodiment, the partners receive notification in the meantime regarding the new auction and they can either login to the portal or respond to the SMS notification to bid against the auction. Partners opted for dynamic offer need to login to the system to configure new offers/choose existing offers for bidding. When the server receives one or more offers for bidding the bids are placed against the auction on behalf of the partner.

According to an embodiment, if the partner places one or more bids within the Bid Discovery Period, the bids are accepted and the status is set to ‘Accepted’. The system pushes the bid to the browser and the browser picks up the bids and updates the bid search engine. But if the partner fails to place first bid within the Bid Discovery period, the bid status is set to ‘Expired’.

According to an embodiment, the customer is allowed to pick a bid and continue with the purchase. If the customer selects a bid and continues, the selected bid status is set to ‘Winning’ and others are set as ‘Rejected’ bids. The customer also may be allowed to pick multiple bids and start a reverse bidding process.

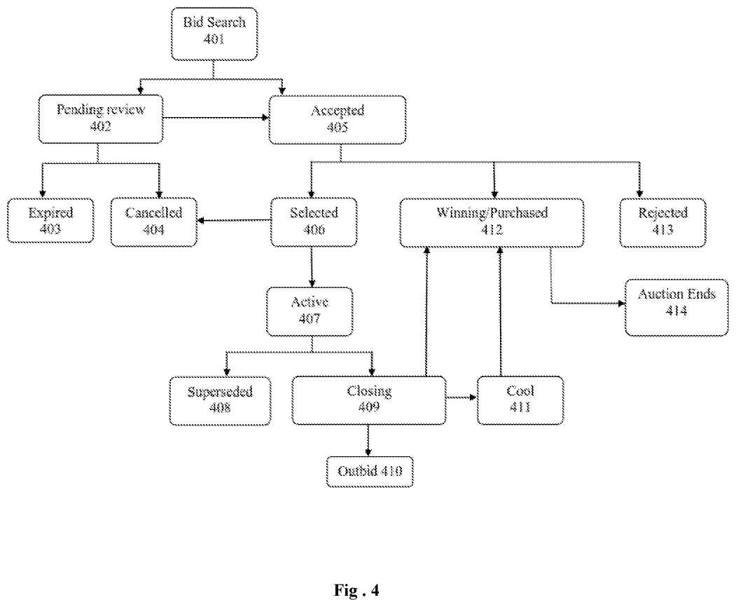

Exemplary methods for implementing system of automated bid configuration and search engine are described with reference to FIG. 1, 2, 3 and FIG. 4. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 1 illustrates a bid search process in the bid search engine, according to an embodiment herein. Assuming that the customer is a valid user and already logged in to the system, he visits the “bid calendar”; keys in desired date, time, budget and location and sends a bid search request to the Bid Search engine. The Search engine performs a full text search in the partner indexed data and the result is passed on to the DataLoader computer program which loads the latest data from the relational database and passes to the Bidding options Filter Computer program.

According to an embodiment, BiddingOptionsFilter loops through each partner record. If partner has chosen and configured the “Dynamic Offer” option, a notification request for the offer is created and added to the notification list. For partner record with no dynamic offer, all pre-configured offers are fetched from database. BSE evaluates various rules defined in the “Bidding Options” for each offer and accordingly determines the eligibility of the offer for bidding. If the offer's “Bidding Options” criteria don't match with the bid search criteria, the offer is skipped.

According to an embodiment, BiddingOptionsFilter also validates if the budget of the customer for the desired good/service is within the budget of the offer. If the customer budget is not within the offer budget and Partner has configured for “Review Before Bidding”, a notification request for the offer is created and added to the notification list. The offer is added to the eligible offer list with “Pending Review” status. If the customer budget is not within the offer budget and Partner has not configured for notification, the offer is omitted. If the customer budget is within the offer budget and Partner has configured for “Auto Bid”, the offer is added to the eligible offer list with “Accepted” status. If the customer budget is within the offer budget and Partner has configured for “Review Before Bidding”, a notification request for the offer is created and added to the notification list.

According to an embodiment, the offer is added to the eligible offer list with “Pending Review” status and all the eligible offer records are added to the list. If there is at least one eligible offer in the list, a new Auction is automatically created in the system. The list of eligible offers is then passed to the “OfferBidEngine” which loops through each offer and if the offer has “Accepted” status, system places a new bid against the new Auction on behalf of the partner. Appropriate price is set for the bid in the bid search list. If the offer has “Pending Review” status, an approval flow is initiated by the system. “None” is set as the price for the bid in the bid search list.

According to an embodiment, the partner is notified about the new auction to provide offers for bidding within the Bid Discovery Period. The final bid list is simultaneously passed onto various engines which include ranking engine, rating engine and bid status engine.

According to an embodiment, the final result is serialized to JSON and written back to the response which is built in the search listing page.

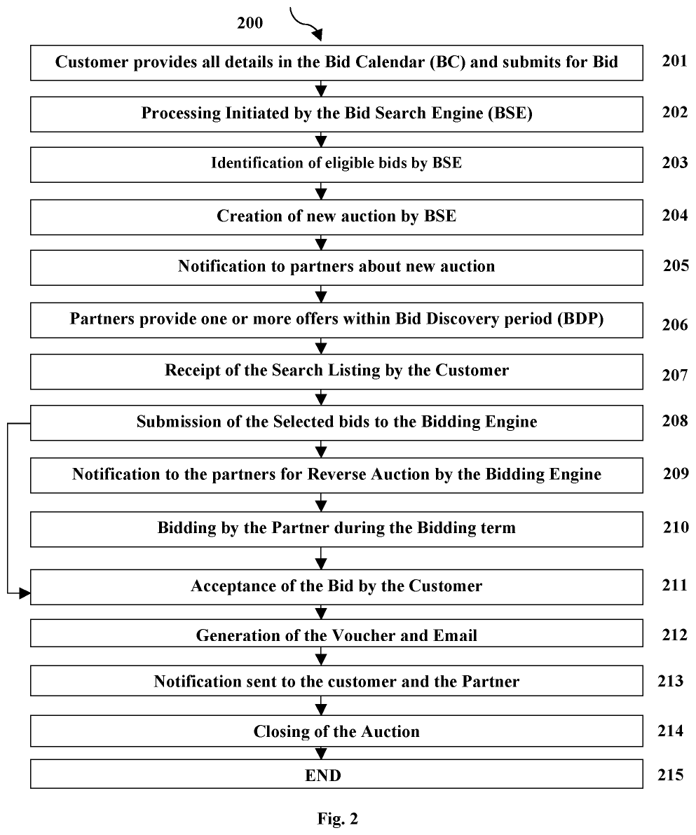

FIG. 2 illustrates a flow chart showing Auction and Bidding process, according to an embodiment.

According to an embodiment, the customer provides all the details in the Bid Calendar 201 and submits the request to the Bid Search Engine (BSE) 202 which further identifies all the bids 203 and creates a new Auction 204.

According to an embodiment, the BSE places all the eligible bids against this auction wherein none or few bids may be in “Pending review state” that requires that the partner must provide one or more offers for bidding against the auction.

According to an embodiment, the partners are notified about the new auction 205 and if they are interested they are expected to provide one or more offers (new/existing) within the Bid Discovery Period 206.

According to an embodiment, the customer may choose to wait until the expiry of Bid Discovery period or buy any of the listed ‘Accepted’ bids at any point of time or allow negotiation among the listed bids.

According to an embodiment, If customer wants to further allow negotiation among the listed bids, he can select two or more “Accepted” bids from the listing and add those for bidding process within the Bid Term (BT). If no BT is defined, the system determines the BT based on it's internal algorithm. Customer can also choose to provide more information on his expectation on the goods or services he is looking for. The chosen list of “Accepted” bids along with other information are submitted to the Bidding Engine (BE) wherein BE disqualifies the bids which aren't part of the selected list of bids and notifies the respective partners.

According to an embodiment, the partners with Accepted bids are requested to bid further 209. Reverse bidding process (RBP) is considered here where the partners are expected to provide a bid with lower monetary value (i.e. higher benefits for customer) then the current bid.

According to an embodiment, partner may choose to stop bidding or lower the price or provide more benefits in the same budget. This bidding process will continue for a predefined Bidding Term. Partner may review bids placed by other partners. Details of other participating partners are not revealed to the Partners during the Bidding Term. Details of the customer are not revealed to the Partners during the Bidding Term. Details of participating partners are revealed to the customer. Partner may bid one or more times 210 to outbid other partners during the Bidding Term (BT).

According to an embodiment, The Bidding Engine (BE) evaluates all the qualified bids and picks up a Coolest Bid based on the Bidding Engine's (BE) internal algorithm and present the customer with the coolest bid and other qualified bids. Customer may either choose the coolest bid or any other qualified bid listed in the final list for acceptance of the bid 211. If the customer is picking up the winning bid, the reason for liking the winning bid is captured from the customer to understand the customer's buying behavior/pattern.

According to an embodiment, all the partners along with the winning partner are notified 213. The Bidding engine also notifies the Deal Voucher Service about the winning bid after which one or more vouchers 212 with unique voucher codes are generated and their details are mailed to the customer.

According to an embodiment, the voucher details can also be viewed in the bidding portal in ‘My Voucher’ section. The auction is set to ‘closed’ by the Bidding Engine.

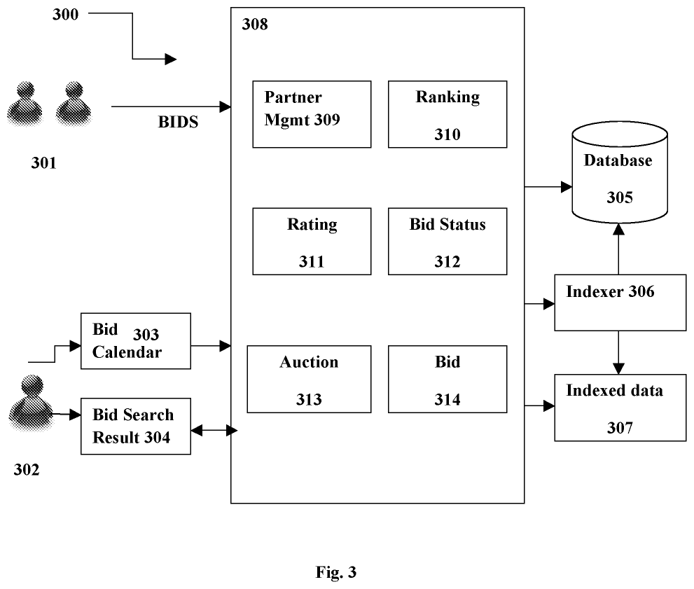

FIG. 3 illustrates the block diagram of the different components in the system, according to an embodiment herein.

According to an embodiment, the bidding system 300 is a software system having number of modules performing various functions and working seamlessly together. The FIG. 3 illustrates the main modules of the system if built in an object oriented programming environment like Java/JEE technologies. the portal built on technologies like JSON, HTML, Javascript, JQuery, Spring, Hibernate, SQL, Solr, Apache ActiveMQ, Apache Storm, Python, Machine Learning techniques and Artificial Intelligence which are a free and open source technological platforms and has features required for the development of websites, portals and mobile applications.

According to an embodiment, servers, database, load balancer, firewall deployed within cloud and clients connected to the software system using the browser client or mobile device over the internet or mobile network are used.

According to an embodiment, Bidding System 300 is a browser based presentation module which provides online bid search, auction and bidding facility to partners, customers, system and guest users. It offers variety of features like, providing the Bid Calendar page 303 where customer/guest user 302 can perform search for bids; providing user interface for customer 302 (logged in) where customer 302 can perform bid search 304, view their notifications, ongoing auctions, auction history and other auction related details, modify ongoing auctions, accept/reject auctions, etc; providing user interface for partner 301 (logged in) where partner can view all the notifications, ongoing auctions, bid history and other auction related details, place bids, accept/reject auctions, etc., create and manage offers and view bid grid; and providing user interface for system user (logged in) where system user can manage the auction and bidding process (if necessary).

According to an embodiment, an administration system module provides administrative functionality to partners 301, customers 302 and system users; feedback system module allows the customers and partners to provide feedback on the products and services; helpdesk module provides the customer with information and support on the products and services the system is providing; dashboard module is designed to display summaries, graphics and gauges to provide the customers information to track all functions and customer module provides the capability to define and maintain the data used by a business to track and service its customers.

According to an embodiment, the partner 309 component provides the capability to define and maintain the data used by a business to track and service its partners along with the features including defining the information used by the system to record, maintain, track and service partners of the system, holds the contact information responsible for communication between the system and it's partners, maintains the relationship between partner and other components that may contain information relevant to partner.

According to an embodiment, the auction 313 component provides the capability to define and maintain the data used by a business to track all the auctions created by the customers of the system. The auction 313 component offers variety of features including defining the information used by the system to record, maintaining, tracking auction process in the system, holding all the search information provided by the customer in the bid calendar, holding the information of the auctioneer and the bidders, maintaining the relationship between the auctioneer and the bidders, maintaining the relationship the bidders and their bids, holds the information of the winning bid, maintaining the relationship between auction and other components that may contain information relevant to auction.

According to an embodiment, the bid component 314 provides the capability to define and maintain the data used by a business to track all the bids created by the partners of the system. In the system, bid is the value offered by the producer/provider for the goods or services. The bid component 314 offers variety of features including defining the information used by the system to record, maintain, track a bid in the system, holding the information provided by the bidder for the specific bid, maintaining the relationship between bid and other components that may contain information relevant to bid.

According to an embodiment, the feedback component provides the capability to define and maintain the data used by a business to track all the feedbacks provided by the customers/partners of the system; the tickets component provides the capability to define and maintain the data used by a business to track all the support tickets filed by the customers/partners of the system; the system user component provides the capability to define and maintain the data used by a business to track and service its system users; Dashboard and Widgets component provides the capability to define and maintain the data used by a business to display customized dashboard and widgets to partners, customers & system users; Survey Service component which is a backend component provides the system with capability to manage feedbacks in the system; and Notification service component provides the system with capability to send notification to the intended recipient using various notification mechanism like email, sms etc.

According to an embodiment, the Bid Search Engine 308 component which is a backend component, provides the system with capability to perform search live bids based on customer bid search criteria and further provides business methods to perform Search bids based on search criteria and the Bidding Engine component which is a backend engine provides the system with capability to manage auction and bids. It further provides the business methods to Create a new auction based on search criteria, Fetch auction details, Update auction details, Rejects auction, Invalidate auction, End auction, Place bid on auction, Fetch all bids for auction, Fetch winning bid for auction, Fetch final bids for auction, Fetch all active auctions and Fetch all active auction by customer/partner.

According to an embodiment, the Messaging Engine component provides the system with capability of asynchronous communication among components; Audit Service component provides the system with capability of auditing all the business methods in the system; Identity Service component provides the system with capability of Authentication & Authorization of the users of the system; Persistence Service component provides the system capability to manage persistent objects using database specific drivers to manage the data in the database; SMS Service component provides the system capability to send SMS to an intended mobile number; Email Service component provides the system capability to send Email to an intended email address; Rule Engine component provides the system capability to validate, parse and execute business rules which are in form of expression; and Solr Engine component provides the system capability to perform full-text search on huge amount of data which may be used by other internal components like Bid Search Engine.

According to an embodiment, the Ranking Engine 310 component provides the system capability to perform ranking of bids on the bid search result; the database component provides the system capability to define, persist, retrieve, update, delete and administrate data used by the system; and the Analytics engine component provides the system capability to perform various business analytics on the data captured by the system. The results of various business analytics are made available to customers, partners & systems users (based on the privilege) in dashboard and in form of reports.

FIG. 4 illustrates a bid state diagram, according to an embodiment herein.

According to an embodiment, as shown in the FIG. 4, each of the ovals represents a state of a bid and the test adjacent to the arrows (edges) represent transitions from one state to another as caused by the input.

A main advantage of the present invention is that the system and method enables the customers/buyers to initiate an auction for a required good or service within their budget.

Another advantage of the present invention is that the system and method provides the buyers with an option for defining the price and choosing the sellers for the same goods or services.

Still another advantage of the present invention is that the system and method provides the buyers to gain benefit on the price of the desired goods or services and also choose the right sellers.

Yet another advantage of the present invention is that the system and method benefits the sellers by providing the information from their competitors on their price, their rankings, their services, terms and conditions on selling the goods to the customers.

Another advantage of the present invention is that the system and the method help both buyers and the sellers save their valuable time by eliminating the manual work on this process.

Yet another advantage of the system and the method is that it enables the buyers to initiate an auction for a required good or service within their budget and preferred vendors.

Still another advantage of the present system and method is that it would greatly help the buyers and the sellers on the returns on their spend and time.

Another advantage of the present system and method is that the invention can be used in hospitals to procure medicines, instruments, manpower, consumables etc. It may help the hospitals to procure their abovementioned requirements in their desire budget, thus helping them to control the treatment cost.

Yet another advantage of the present system and method is that, owing to the fully automatic nature of the present invention un-necessary bureaucracy and corruption during manual handlings and/or procurements may be avoided during goods procurement for Govt. and/or Private sectors.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method (200) for automated bid configuration and search engine for enabling the user to search for the bids for goods or service within the user's or customer's desired budget and preferred vendors; wherein the method comprises the steps:
submitting (201) bid details in the bid calendar by the customer; wherein the bid details include information related to goods or services, desired budget, a bid discovery period and the date;
processing (202) initiated by a Bid Search engine; wherein the Bid Search Engine performs full text search in the partner or seller data;
identifying (203) the eligible bids by the bid search engine; wherein if there is at least one eligible bid, a new auction created (204);
notifying (205) the partners or sellers regarding the new auction wherein the partner or seller provides the price for the bid and approves bidding;
receiving (206) the bidding details from the sellers or partners within a Bid Discovery period;
receiving (207) of the search listing by the customer, wherein the complete bid search results with initial bid price presented prior to the expiry of the Bid Discovery Period wherein the customer selects the bid and continues with the purchase or the customer selects multiple bids and initiates a reverse bidding process;
submitting (208) the selected bids to the bidding engine by the customer;
notifying (209) the partners or sellers for the reverse auction by the bidding engine;
bidding (210) by the partner or seller during the Bidding Term wherein the seller or partner further bids with lower monetary value or higher worth value; wherein on the expiry of the Bid term period, the auction stops accepting further bids;
determining a ‘Cool’ bid based on the internal algorithms, wherein the customer is notified about the end of the auction;
accepting (211) of the ‘Cool’ bid by the customer, wherein the customer further states the reason for liking the ‘Cool’ bid;
generation (212) of a voucher for the winning bid and emailing a voucher to the customer; and
notifying (213) the seller or partner of the winning bid; and closing (214) of the auction.

2. The method (200) as claimed in claim 1, wherein a bid discovery period is the time lag between the start and completion of the search.

3. The method (200) as claimed in claim 1, wherein the partner or seller (301) places more than one bids within the Bid Discovery period.

4. The method (200) as claimed in claim 1, wherein a reverse bidding process is the bidding process where the partners or sellers provide a bid with lower value or higher worth value than the current bid.

5. The method (200) as claimed in claim 1, wherein the customer (302) provides information related to goods or services, desired budget, a bid discovery period, date and other desired details as search criteria to perform the bid search (201) in a Bid Calendar.

6. The method (200) as claimed in claim 5, wherein a bid calendar is a bid search form, wherein the customer provides desired budget, date and other desired details as search criteria to perform the bid search in the system (300) using a bid search engine (308).

7. The method (200) as claimed in claims 1 and 6, wherein the bid search engine (308) is responsible for performing search of all bids matching the search criteria.

8. A system (300) for automated bid configuration and search engine, wherein the system comprises
a user interface, a bidding engine 308, a cloud communication layer and a database (305).
wherein the user interface provided for facilitating the customers (302) and partners (301) to register in the system, search & bid in the system and purchase and/or sell the desired goods and service;
wherein the bidding engine configured (308) for managing auctions and bids;
wherein the bidding engine includes:
a Bid Search component (304) configured for searching bidding details to get the live bids;
a partner management component (309) configured to define and maintain partner or seller data;
a ranking component (310) configured to rank each bid according to the search criteria;
a rating component (311) configured to rate the bid according to the user or buyer feedback;
a bid status component (312) configured to check the bid status;
an auction component (313) configured to provide the capability to define and maintain the data to track all the auctions; and
a bid component (314) configured to define and maintain bids.

9. The system (300) as claimed in claim 8, wherein the system 300 creates an auction automatically upon receiving the search information.

10. The system (300) as claimed in claim 8, wherein a bidding summary report (BID GRID) for a particular auction generated for the partners (301) which enables the partners (301) to analyze bidding strategy of other partners to improve their bidding skills for future auctions.

11. The system as claimed in claim 8, wherein the Bid Search Engine (308) performs full text search in the partners or sellers (301) indexed data to determine the eligibility of the partner for bidding.
